(19) United States
(12) Patent Application Publication
(10) Pub. No.: US 2007/0294389 A1
(43) Pub. Date: Dec. 20, 2007

(54) Method and apparatus for performing call trace filtering in a signal analyzer system

(76) Inventors: Samuel M. Bauer, Colorado Springs, CO (US); Andrew Donaghey, Edinburgh (GB); Merlin A. Rhoda, Reno, NV (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/412,304

(22) Filed: Apr. 27, 2006

(51) Int. Cl. G06F 15/173

(52) U.S. Cl. 709/224

(57) ABSTRACT

The invention provides a method and an apparatus for performing high-level filtering processes on data prior to the data being stored in the capture buffer, or on data that is currently stored in the capture buffer. In both cases, the amount of data that is ultimately paged from the capture buffer to other storage devices is reduced. In addition, signal analyzer resources, such as data collection probes, for example, can be shared without users having to view data that is not relevant to them.

### TECHNICAL FIELD OF THE INVENTION

The invention relates to signal analyzer systems used to monitor and diagnose communications networks. More particularly, the invention relates to a signal analyzer system that is capable of performing call trace filtering on data prior to the data being stored in the capture buffer and/or while the data is stored in the capture buffer.

### BACKGROUND OF THE INVENTION

A signal analyzer system is a piece of equipment that is attached to a communications network and used to monitor traffic and diagnose problems on the network. FIG. 1 illustrates a block diagram of a known signal analyzer system 2. The signal analyzer system 2 includes distributed network analyzer data collection probes 3 that attach the system 2 to a point in the network (not shown), a computer system 4 that receives network data from the probes 3 and processes the data, and a display device 5 that displays information to a user via a user interface (UI) to enable the user uses to monitor traffic on the network and diagnose network problems.

The computer system 4 includes one or more processors (not shown) programmed to execute various application software programs that process the data received from the probes 3 in accordance with various algorithms and cause data to be displayed on the display device 5 in windows, or views. The data obtained by the probes 3 is transmitted in cells that can contain up to a particular number of bytes (e.g., 63 bytes per cell for asynchronous transfer mode (ATM) data). The computer system 4 removes the payloads from the cells and reassembles them into units known as messages. These messages may correspond to different protocols depending on the location at which the data is collected from in the network. Some messages are control plane messages that control data flow, call establishment, call tear down, etc. Other messages are user plane messages that carry voice, data or video.

The computer system 4 decodes these messages and displays them in a traffic overview window, which presents messages as single lines that contain the information about the messages that is most relevant to the user viewing the data. The computer system 4 also performs call trace (CT) decoding, which decodes messages and groups them based on the calls with which they are associated. This information is displayed on the display device 5 as CT views. The CT information indicates to the user significant occurrences at various phases of the call, such as when a network connection was made, when a call response was sent, disconnection problems associated with the call, the reason for the disconnection, etc.

FIG. 2 illustrates a block diagram of a buffer capture component 12 of the computer system 4 shown in FIG. 1. The buffer capture component 12 includes a capture buffer 14 that stores data received in the computer system 4 from the probes 3. The capture buffer is typically an area in the random access memory (RAM) of the computer system 4. A message parsing and formatting component 15 of the buffer capture component 12 pulls messages from the buffer 14, parses them based on message type, and passes them along to the proper application programs. The application programs receive the messages and display them in views on the display device 5. A buffer monitoring and data paging component 16 of the buffer capture component 12 monitors the amount of data contained in the buffer 14 and periodically pages data to a disk storage device in order to free up space in the buffer 14.

Several types of filtering processes can be performed by the computer system 4. The user sets certain filtering criteria and the computer system 4 filters in accordance with those criteria. One type of filtering that can be performed by the computer system 4 is a low-level filtering process that filters based on criteria such as message protocol, virtual path identifier (VPI) and virtual channel identifier (VCI). A number of these types of filters can be set to allow the computer system 4 to filter down through the traffic overview. Another type of filtering process that can be performed by the computer system 4 is CT filtering, which is a high-level filtering that filters based on criteria such as a particular international mobile subscriber identity (IMSI), temporary mobile subscriber identity (TMSI), international mobile equipment identity (IMEI), Internet Protocol (IP) address, and mobile subscriber Integrated Services Digital Network (MSISDN).

The aforementioned low-level filtering process is typically performed on the data prior to it being stored in the capture buffer 14. However, because this filtering process uses low-level criteria, such as VPI and VCI, which are logical addresses in the network, all of the messages associated with all of the calls that flow through those nodes are not filtered out, and thus become stored in the capture buffer 14. This high-level filtering process is a view filtering process that is performed by the aforementioned application programs after the data has been passed to them by the message parsing and formatting component 15. Therefore, the high-level filtering process does not affect the amount of data that is flowing into the capture buffer 14. Consequently, a large amount of data is saved to disk storage devices by the buffer monitoring and data paging component 16. Further, the signal analyzer system 2 is capable of being set in a mode that allows it to run for days and to periodically page data from the capture buffer 14 to disk storage. In this mode, the amount of data that is paged to the disk storage devices can be extremely large.

It is possible to run multiple instances of the signal analyzer software programs on multiple computer systems that share the same probes. However, when the aforementioned high-level filtering processes are performed, each computer system will process the same data because these filtering processes are performed subsequent to the data being stored in the capture buffer. Consequently, the respective display devices will display data associated with other instances of the signal analyzer software programs being executed by other computer systems sharing the same probes.

A need exists for a way to reduce the amount of data that is ultimately saved on these disk storage devices. A need also exists for a way to allow resources (e.g., data collection probes) to be shared without users having to view data that is not important to them.

### SUMMARY OF THE INVENTION

The invention provides a method and an apparatus for use in a signal analyzer system for performing call trace (CT) filtering of network data. The apparatus comprises a filter engine processor configured to perform CT filtering of network data. The processor receives network data and filters the received data in accordance with selected CT filtering criteria. The processor then stores data that meets the CT filtering criteria in a capture buffer for further processing by one or more components of the signal analyzer system.

The invention also provides a signal analyzer system for analyzing network data. The system comprises a capture buffer for storing data and a filter engine processor configured to perform CT filtering of network data in accordance with selected CT filtering criteria. The processor stores data that meets the CT filtering criteria in the capture buffer for further processing by one or more components of the signal analyzer system.

The invention also provides a method for performing CT filtering of network data in a signal analyzer system. The method comprises the steps of receiving network data in a filtering engine processor, processing the received data in the filter engine processor in accordance with selected filtering criteria, and storing data in a capture buffer that meets the selected filtering criteria.

The invention also provides a computer program for performing CT filtering of network data in a signal analyzer system. The program is embodied on a computer-readable medium and comprises instructions for receiving network data in a filtering engine processor, instructions for processing the received data in the filter engine processor in accordance with selected filtering criteria, and instructions for causing data that meets the selected filtering criteria to be stored in a capture buffer.

These and other features and advantages of the invention will become apparent from the following description, drawings and claims.

### BRIEF DESCRIPTION OF THE DRAWINGS

FIG. 1 illustrates a block diagram of a known signal analyzer system.

FIG. 2 illustrates a block diagram of a capture buffer component of the computer system shown in FIG. 1.

FIG. 3 illustrates a block diagram of a signal analyzer system that incorporates the signal apparatus and method of the invention.

FIG. 4 illustrates a block diagram of the signal analyzer apparatus of the invention in accordance with an exemplary embodiment, which may be incorporated into the computer system shown in FIG. 3.

FIG. 5 illustrates a block diagram of the signal analyzer apparatus of the invention in accordance with another exemplary embodiment, which may be incorporated into the computer system shown in FIG. 3.

FIG. 6 illustrates a block diagram of the signal analyzer apparatus of the invention in accordance with another exemplary embodiment, which may be incorporated into the computer system shown in FIG. 3.

FIG. 7 illustrates a flowchart that demonstrates the method of the invention in accordance with an exemplary embodiment.

### DETAILED DESCRIPTION OF AN EXEMPLARY EMBODIMENT

The invention provides a method and an apparatus for performing high-level filtering processes on data prior to the data being stored in the capture buffer, or on data that is currently stored in the capture buffer. In both cases, the amount of data that is ultimately paged from the capture buffer to other storage devices is reduced. In addition, signal analyzer resources, such as data collection probes, for example, can be shared without users having to view data that is not relevant to them.

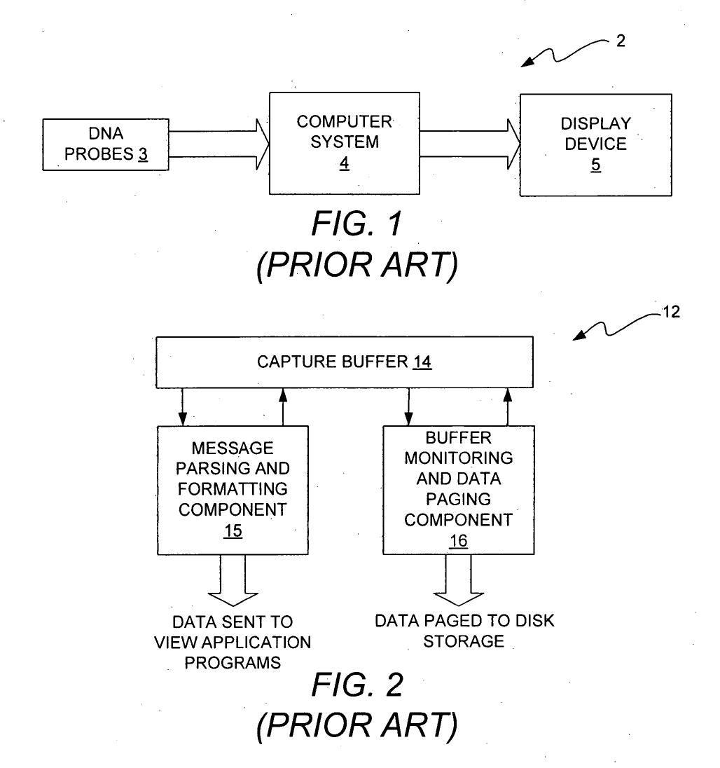

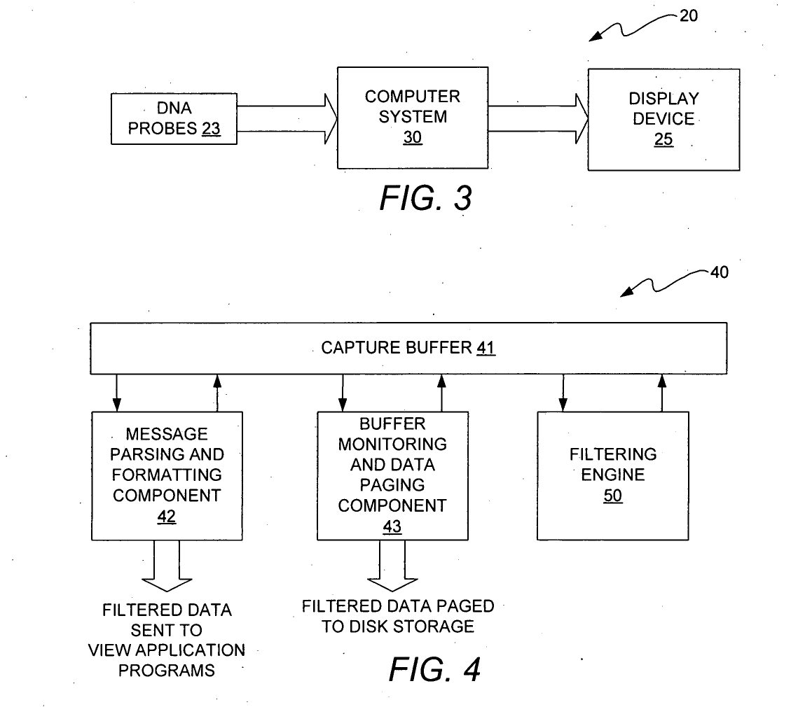

FIG. 3 illustrates a block diagram of a signal analyzer system 20 that incorporates the signal apparatus and method of the invention. The probes 23 and the display device 25 may be similar or identical to the probes 3 and display device 5, respectively, shown in FIG. 1. The computer system 30 incorporates the signal analyzer apparatus and method of the invention.

FIG. 4 illustrates a block diagram of the signal analyzer apparatus 40 of the invention in accordance with an exemplary embodiment, which is incorporated into the computer system 30 shown in FIG. 3. The apparatus 40 includes a capture buffer 41, a message parsing and formatting component 42, a buffer monitoring and data paging component 43, and a filtering engine 50. The filtering engine 50 filters data stored in the buffer 41 based in CT filtering criteria, and tags data that matches the filtering criteria.

The components 42 and 43 generally perform the same functions as described above with reference to components 15 and 16, respectively. However, the components 42 and 43 preferably only process data that has been tagged by the filter engine 50. Thus, the software application programs which receive data from the message parsing and formatting component 42 only process data that has been filtered in accordance with the CT filtering criteria. Consequently, only data that has been filtered in accordance with the selected CT filtering criteria is displayed to the user in corresponding views on the display device 25.

Similarly, the buffer monitoring and data paging component 43 only pages data from the capture buffer 41 that has been tagged. Consequently, only data that has been filtered in accordance with the selected CT criteria is paged to disk storage, which reduces the overall amount of storage space needed for storing paged data.

The CT filtering process in accordance with the invention is based on criteria such as, for example, IMSI, TMSI, IMEI, IP address, and MSISDN. The CT filtering process groups messages based on the selected filtering criteria. The views that are then displayed on the display device 25 are limited to the filtered data. This aspect of the invention allows resources, such as data collection probes, for example, to be shared by multiple users running respective instances of the software analyzer program without causing data that does not correspond to their respective filtering criteria to be displayed on their respective display devices. In other words, when multiple users are sharing signal analyzer resources, it does not appear to them that they are sharing resources because the views that are displayed to them on their display devices are limited to data that has been filtered in accordance with their selected filtering criteria.

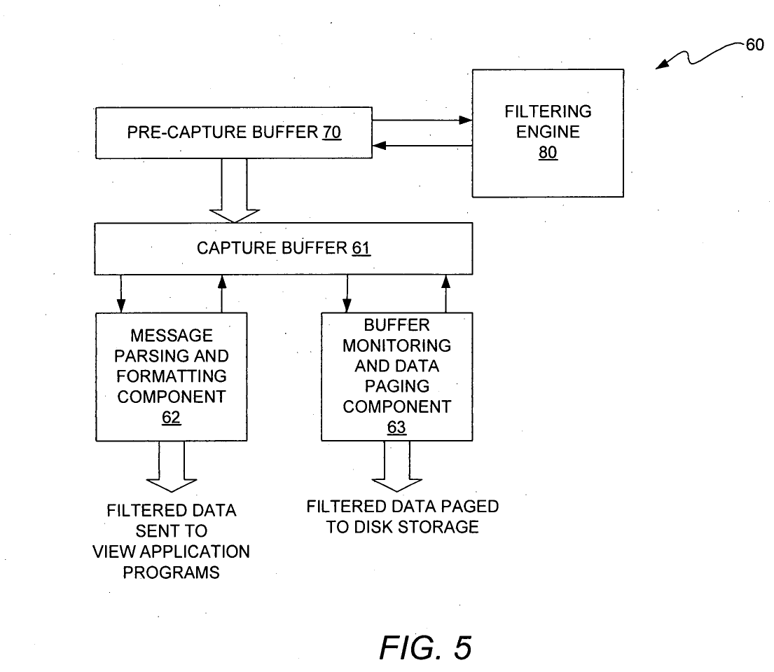

FIG. 5 illustrates a block of the signal analyzer apparatus 60 of the invention in accordance with another exemplary embodiment. The apparatus 60 includes a capture buffer 61, a message parsing and formatting component 62, a buffer monitoring and data paging component 63, a pre-capture buffer 70, and a filter engine 80. In accordance with this embodiment, data is filtered prior to being stored in the capture buffer 61. Incoming data is stored in the pre-capture buffer 70. The filter engine 80 filters data stored in the pre-capture buffer 70 based on selected CT filtering criteria. The data that meets the filtering criteria is then tagged in the pre-capture buffer 70. The tagged data is then stored in the capture buffer 61. Messages that are contained in the pre-capture buffer 70 that are not tagged are discarded after a period of time.

The components 62 and 63 generally perform the same functions as described above with reference to components 15 and 16, respectively. However, because the data contained in the capture buffer 61 has already been filtered, the components 62 and 63 preferably only process data that has been filtered by the filter engine 80. Thus, the software application programs which receive data from the message parsing and formatting component 62 only process data that has been filtered in accordance with the CT filtering criteria. Consequently, only data that has been filtered in accordance with the selected CT filtering criteria is displayed to the user in corresponding views on the display device 25. Similarly, the buffer monitoring and data paging component 63 only pages data from the capture buffer 61 to disk storage that has been filtered, which reduces the overall amount of storage space needed for storing paged data.

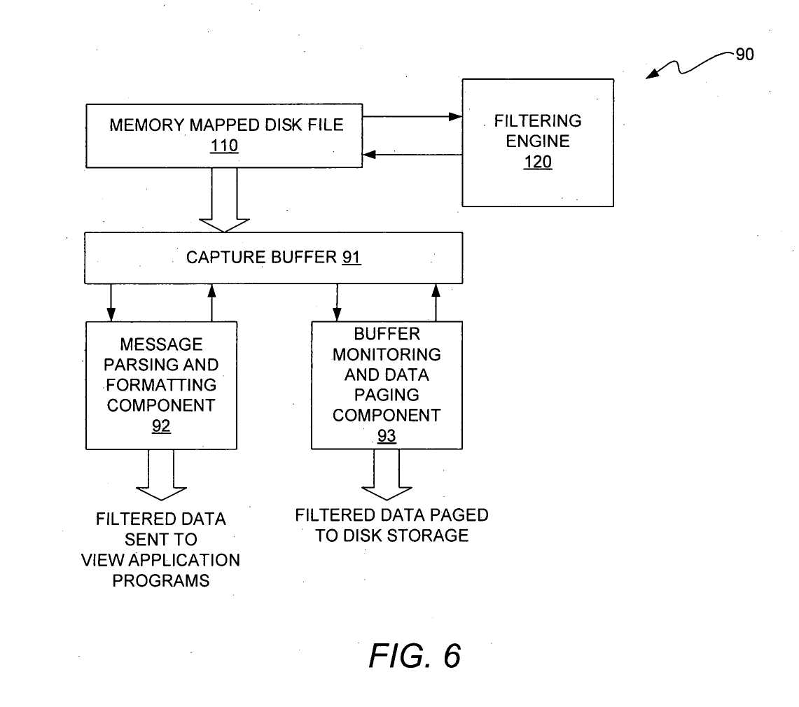

FIG. 6 illustrates a block of the signal analyzer apparatus 90 of the invention in accordance with an exemplary embodiment. The apparatus 90 includes a capture buffer 91, a message parsing and formatting component 92, a buffer monitoring and data paging component 93, a pre-capture memory mapped disk file 110, and a filter engine 120. As with the embodiment described above with reference to FIG. 4, in accordance with this embodiment, data is filtered prior to being stored in the capture buffer 91. Incoming data is mapped into the memory mapped disk file 110. The filter engine 120 filters data stored in the disk file 110 based on selected CT filtering criteria. When a sufficient number of messages have been processed by the filter engine 120 to group them into a call and positively match the filtering criteria, all messages belonging to the call are copied into the capture buffer 91.

The components 92 and 93 perform the same functions as described above with reference to components 62 and 63, respectively, shown in FIG. 5. Thus, the software application programs which receive data from the message parsing and formatting component 92 only process data that has been filtered in accordance with the CT filtering criteria. Consequently, only data that has been filtered in accordance with the selected CT filtering criteria is displayed to the user in corresponding views on the display device 25. Similarly, the buffer monitoring and data paging component 93 only pages data from the capture buffer 91 to disk storage that has been filtered, which reduces the overall amount of storage space needed for storing paged data.

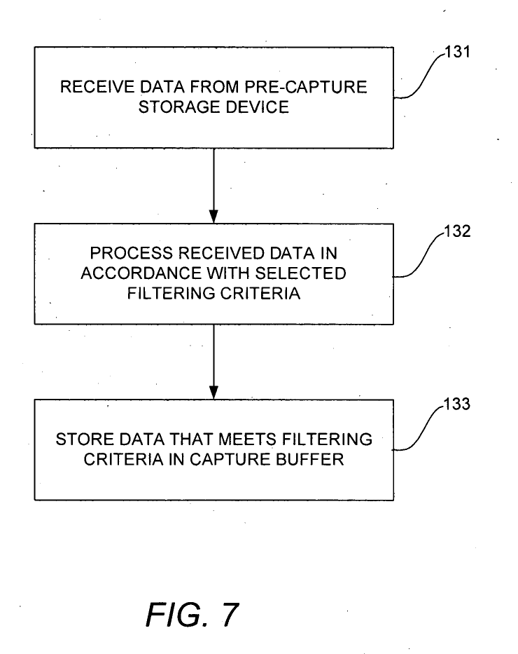

FIG. 7 illustrates a flowchart that demonstrates the method of the invention in accordance with an exemplary embodiment. The method of the invention is performed by any one of the apparatuses 50, 80 and 120 shown in FIGS. 4, 5 and 6, respectively. The method may be performed in hardware, software, or a combination of hardware, software and/or firmware. The apparatuses 50, 80 and 120 typically include, or are in communication with, respective computer-readable memory devices that store the computer instructions and data associated with performing the method.

With respect to FIG. 7, the filter engine receives (e.g., pulls) data from the capture buffer (FIG. 4) or pre-capture storage device (FIGS. 5 and 6), depending on which implementation is used. This step is represented in FIG. 7 by block 131. The filter engine then processes the data in accordance with selected high-level filtering criteria, as indicated by block 132. The filtered data is then stored in the capture buffer (or other memory element) for further processing by other components (e.g., 42, 43, 62, 63, 92, 93) of the signal analyzer computer system, as indicated by block 133.

As described above, the invention reduces the amount of data that is processed by the components of the computational system downstream of the capture buffer, as well as the amount of data that is ultimately paged to disk storage devices. In addition, the invention ensures that only data that meets the selected filter criteria will be displayed in views of the display device 25. This feature of the invention allows the user to better analyze the data and facilitates sharing of signal analyzer resources.

It should be noted that the invention has been described with reference to exemplary embodiments and that the invention is not limited to these embodiments. Those skilled in the art will understand that modifications may be made to the embodiments described above, and that all such modifications are within the scope of the invention.

What is claimed is:

1. An apparatus for use in a signal analyzer system for performing call trace (CT) filtering of network data, the apparatus comprising:
a filter engine processor configured to perform CT filtering of network data, the processor receiving network data and filtering the data in accordance with selected CT filtering criteria, the processor storing data that meets the CT filtering criteria in a capture buffer for further processing by one or more components of the signal analyzer system.

2. The apparatus of claim 1, further comprising:
a data storage device configured to store network data, wherein the data that is processed by the filter engine processor is received by the processor from said data storage device.

3. The apparatus of claim 1, wherein the data that is processed by the filter engine processor is received by the processor from the capture buffer.

4. The apparatus of claim 2, wherein the data storage device is a buffer.

5. The apparatus of claim 2, wherein the data storage device is a magnetic disk.

6. The apparatus claim 1, wherein data that is processed by the filter engine processor that does not meet the selected filter criteria is discarded.

7. The apparatus of claim I, wherein the CT filtering criteria includes one or more of an international mobile subscriber identity (IMSI), a temporary mobile subscriber identity (TMSI), an international mobile equipment identity (IMEI), an Internet Protocol (IP) address, and a mobile subscriber Integrated Services Digital Network (MSISDN).

8. A signal analyzer system for analyzing network data, the system comprising:
a capture buffer for storing data; and
a filter engine processor configured to perform CT filtering of network data, the processor receiving network data and filtering the data in accordance with selected CT filtering criteria, the processor storing data that meets the CT filtering criteria in the capture buffer for further processing by one or more components of the signal analyzer system.

9. The signal analyzer system of claim 8, further comprising:
a data storage device for storing data, wherein the data that is processed by the filter engine processor is received by the processor from said data storage device.

10. The signal analyzer system of claim 8, wherein the data that is processed by the filter engine processor is received by the processor from the capture buffer.

11. The signal analyzer system of claim 9, wherein the data storage system is a buffer.

12. The signal analyzer system of claim 9, wherein the data storage device is a magnetic disk.

13. The signal analyzer system of claim 8, wherein data that is processed by the filter engine processor that does not meet the selected filter criteria is discarded.

14. The signal analyzer system of claim 8, wherein the CT filtering criteria includes one or more of an international mobile subscriber identity (IMSI), a temporary mobile subscriber identity (TMSI), an international mobile equipment identity (IMEI), an Internet Protocol (IP) address, and a mobile subscriber Integrated Services Digital Network (MSISDN).

15. A method for performing call trace (CT) filtering of network data in a signal analyzer system, the method comprising:
receiving network data in a filtering engine processor;
processing the received data in the filter engine processor in accordance with selected filtering criteria; and
storing data in a capture buffer that meets the selected filtering criteria.

16. The method of claim 15, further comprising:
prior to processing the data in the filter engine processor, storing the data in the capture buffer, wherein the filtering engine processor receives the network data after it is read out of the capture buffer.

17. The method of claim 15, further comprising:
prior to processing the data in the filter engine processor, storing the data in a data storage device, wherein the filtering engine processor receives the network data after it is read out of the data storage device.

18. The method of claim 17, wherein the data storage device is a buffer.

19. The method of claim 17, wherein the data storage device is a magnetic disk.

20. The method of claim 15, wherein data that is processed by the filter engine processor that does not meet the selected filter criteria is discarded.

21. The method of claim 15, wherein the CT filtering criteria includes one or more of an international mobile subscriber identity (IMSI), a temporary mobile subscriber identity (TMSI), an international mobile equipment identity (IMEI), an Internet Protocol (IP) address, and a mobile subscriber Integrated Services Digital Network (MSISDN).

22. A computer program for performing call trace (CT) filtering of network data in a signal analyzer system, the program being embodied on a computer-readable medium, the program comprising:
instructions for receiving network data in a filtering engine processor;
instructions for processing the received data in the filter engine processor in accordance with selected filtering criteria; and
instructions for causing data that meets the selected filtering criteria to be stored in a capture buffer.
